(19) United States
(12) Patent Application Publication
(10) Pub. No.: US 2002/0132113 A1
(43) Pub. Date: Sep. 19, 2002

(54) Method and system for making a micromachine device with a gas permeable enclosure

(75) Inventors: Tomoki Tanaka, Allen, TX (US); Risaku Toda, Plano, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX

(21) Appl. No.: 10/052,407

(22) Filed: Jan. 18, 2002

Related U.S. Application Data
(63) Continuation-in-part of application No. 09/688,722, filed on Oct. 16, 2000.
Application No. 09/688,722 is a continuation-in-part of application No. 09/483,640, filed on Jan. 14, 2000, now Pat. No. 6,197,610.

(51) Int. Cl. B05D 5/12; B05D 3/12

(52) U.S. Cl. 428/343; 427/294; 427/346; 427/58

(57) ABSTRACT

A method for coating a micro-electromechanical system (MEMS) device is provided. A coating material, such as a ceramic slurry, may be utilized to form a gas permeable enclosure or shell around the device after the coating material hardens. A vacuum may be applied near the device to exert an attractive force on the coating material to aid in homogenously distributing the coating material over the device. In addition, a vibration may be applied to the device to aid in distributing the coating material. If the device is attached to a substrate, a hole may be formed through the substrate with one opening near the device and a second opening located elsewhere. The vacuum may then be applied to the second opening to draw the coating material over the device and towards the first opening.

### CROSS-REFERENCE

This application is a continuation-in-part of U.S. patent application Ser. No. 09/688,722, filed on Oct. 16, 2000, which is a continuation-in-part of U.S. application Ser. No. 09/483,640, filed Jan. 14, 2000, and issued on Mar. 6, 2001, as U.S. Pat. No. 6,197,610.

### BACKGROUND

The present disclosure relates generally to semiconductor processing, and more particularly, to a system and method for making micro-electromechanical system (MEMS) devices with gas-permeable enclosures.

Integrated circuit devices may need one or more small gaps placed within the circuit. For example, MEMS devices and other small electrical/mechanical devices may incorporate a gap in the device to allow the device to respond to mechanical stimuli. One common MEMS device is a sensor, such as an accelerometer, for detecting external force, acceleration or the like by electrostatically or magnetically floating a portion of the device. The floating portion can then move responsive to the acceleration and the device can detect the movement accordingly. In some cases, the device has a micro spherical body referred to as a core, and a surrounding portion referred to as a shell. Electrodes in the shell serve not only to levitate the core by generating an electric or magnetic field, but to detect movement of the core within the shell by measuring changes in capacitance and/or direct contact of the core to the shell. A coating may be applied to the MEMS device to provide a protective and insulating enclosure around the device and its components.

Due in part to the size of MEMS devices, imperfections created by the manufacturing process may create problems in the structure of a MEMS device that might be insignificant in larger scale applications but may render the MEMS device unusable. Such problems may, for example, include flaws in a coating layer of a MEMS device.

Accordingly, certain improvements are desired for MEMS devices and their manufacturing. For one, it is desirable to provide a coating that is relatively homogeneous and free of voids. Furthermore, it is desired to provide protection, to provide a coating of a desired thickness, to provide high productivity, and to provide a manufacturing process that is more flexible and reliable.

### SUMMARY

A technical advance is provided by a method for coating a micro-electromechanical system device. In one embodiment, the method comprises providing the device mounted on a substrate, where the substrate includes an aperture having a first opening proximate to the device and a second opening. A vacuum is applied to the second opening and a coating material is applied to the device. The vacuum aids in the homogeneous distribution of the coating material on the device by drawing a portion of the coating material over the device towards the first opening.

In another embodiment, the method includes applying a vibration to the device to aid in the distribution of the coating material over the device.

### BRIEF DESCRIPTION OF THE DRAWINGS

FIG. 1 is a flowchart of a manufacturing process for implementing one embodiment of the present invention.

FIGS. 2-5, 6a, 6b, 7a, and 7b are cross sectional views of a spherical shaped accelerometer being manufactured by the process of FIG. 1.

FIG. 8 is a flowchart of a manufacturing process for implementing one embodiment of the present invention of FIG. 1.

FIG. 9 is a cross sectional view of a spherical shaped accelerometer being manufactured by the processes of FIGS. 1 and 8.

FIG. 10 is a flowchart of a method for applying an enclosure around a micro-electromechanical device.

FIG. 11 is a cross sectional view of a spherical shaped accelerometer without the enclosure provided by the method of FIG. 10.

FIG. 12 is a cross sectional view of the accelerometer of FIG. 11 with the enclosure.

FIG. 13 is a cross-sectional view of a spherical shaped accelerometer with multiple gas-permeable enclosures.

FIG. 14 is a cross-sectional view of a spherical shaped accelerometer with a hermetic seal.

### DETAILED DESCRIPTION

The present disclosure relates to semiconductor processing, and more particularly, to a system and method for making a micro-electromechanical system (MEMS) devices with gas-permeable enclosures. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

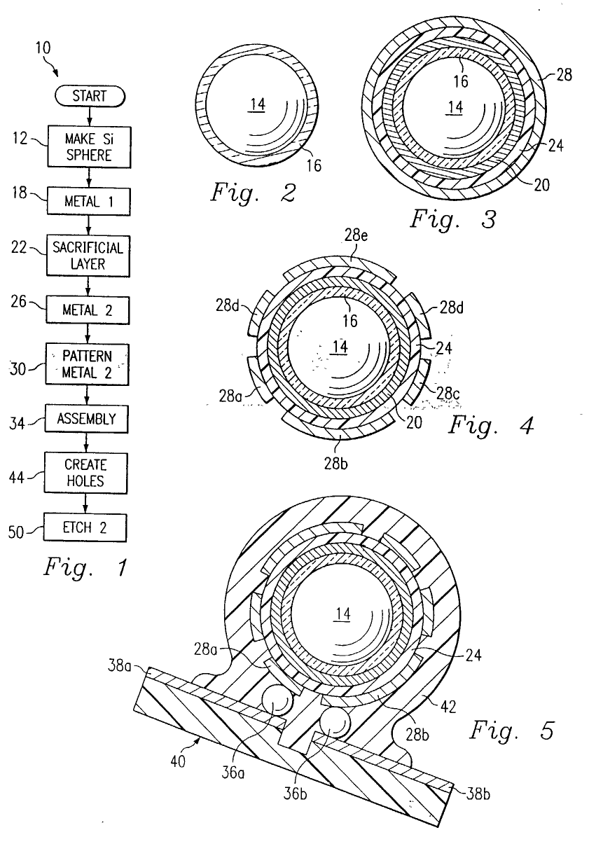

Referring to FIG. 1, the reference numeral 10 refers, in general, to a manufacturing process for making MEMS devices such as is described in U.S. Pat. No. 6,197,610, issued on Mar. 6, 2001, and also assigned to Ball Semiconductor, Inc., entitled “METHOD OF MAKING SMALL GAPS FOR SMALL ELECTRICAL/MECHANICAL DEVICES” and hereby incorporated by reference as if reproduced in its entirety. For the sake of example, FIGS. 2-7b will illustrate a spherical shaped accelerometer that is being made by the manufacturing process 10. It is understood, however, that other MEMS devices can benefit from the process. For example, clinometers, ink-jet printer cartridges, and gyroscopes may be realized by utilizing a similar design.

At step 12 of the manufacturing process 10, a substrate is created. The substrate may be flat, spherical or any other shape. Referring also to FIG. 2, for the sake of example, a spherical substrate (hereinafter “sphere”) 14 will be discussed. The sphere 14 is one that may be produced according to presently incorporated U.S. Pat. No. 5,955,776, issued on Sep. 21, 1999, and also assigned to Ball Semiconductor, Inc., entitled “SPHERICAL SHAPED SEMICONDUCTOR INTEGRATED CIRCUIT,” and to continue with the present example, is made of silicon crystal. On an outer surface 16 of the sphere 14 is a silicon dioxide (SiO2) layer. It is understood that the presence of the SiO2 layer 16 is a design choice and may not be used in certain embodiments. For example, the SiO2 layer 16 may not be used if the substrate 16 will not react with an etchant.

At step 18 of FIG. 1, a first group of processing operations are performed on the substrate. This first group of processing operations represents any operations that may occur before a sacrificial layer is applied (described below, with respect to step 22). Referring also to FIG. 3, in continuance with the example, a first metal layer 20 (hereinafter “metal 1”) is deposited on top of the SiO2 layer 16. The metal 1 layer 20 may be a material such as a chromium film, although other materials may be used. This metal deposition may be created by sputtering. Several different methods, such as is described in U.S. Pat. No. 6,053,123, issued on Apr. 25, 2000, and also assigned to Ball Semiconductor, Inc., entitled “PLASMA-ASSISTED METALLIC FILM DEPOSITION” and hereby incorporated by reference as if reproduced in its entirety.

At step 22 of FIG. 1, a sacrificial layer is applied to the substrate. The sacrificial layer may be applied on top of the previous layers (if any). In continuance with the example of FIG. 3, a sacrificial polysilicon layer 24 is applied on top of the metal 1 layer 20. The sacrificial layer 24 may be applied by sputtering or any conventional manner, such as is described in the presently incorporated patents. Polysilicon is chosen because it reacts well with an etchant discussed below with respect to step 50, but it is understood that other materials can also be used.

At step 26 of FIG. 1, a second group of processing operations is performed on the substrate. This second group of processing operations represents any operations that may occur after the sacrificial layer is applied. In continuance with the example of FIG. 3, a second metal layer 28 (hereinafter “metal 2”) is deposited on top of the sacrificial layer 24. The metal 2 layer 28 may be a gold-chromium (Au/Cr) material, although other materials may be used and the metal 2 layer may have a different composition than the metal 1 layer 20.

At step 30 of FIG. 1, one or more layers of material applied in the second group of processing operations are patterned. The patterning occurs before the removal of the sacrificial layer (described below, with respect to step 50). Referring also to FIG. 4, the metal 2 layer 28 is patterned to produce a plurality of electrodes 28a, 28b, 28c, 28d, and 28e.

The metal 2 layer 28 can be patterned by several different methods. For example, a resist coating may be applied to the metal 2 layer 28, such as is shown in U.S. Pat. No. 6,179,922, issued on Jan. 30, 2001, entitled “CVD PHOTO RESIST DEPOSITION” and/or U.S. Pat. Ser. No. 09/584,913, filed on May 31, 2000, entitled “JET COATING SYSTEM FOR SEMICONDUCTOR PROCESSING,” which are both assigned to Ball Semiconductor, Inc., and hereby incorporated by reference as if reproduced in their entirety.

Once the resist coating has been applied, the coating may be exposed using a conventional photolithography process. In the present embodiment, the etching should not remove the sacrificial layer 24. For example, photolithography processes, such as shown in U.S. Pat. No. 6,061,118, issued on May 9, 2000, entitled “REFLECTION SYSTEM FOR IMAGING ON A NONPLANAR SUBSTRATE” and/or U.S. Pat. No. 6,251,550, issued on Jun. 26, 2001, entitled “MASKLESS PHOTOLITHOGRAPHY SYSTEM THAT DIGITALLY SHIFTS MASK DATA RESPONSIVE TO ALIGNMENT DATA,” which are both assigned to Ball Semiconductor, Inc., and hereby incorporated by reference as if reproduced in their entirety, may be used. In the present example, the metal 2 layer 28 is the only layer that is patterned. For this reason, there is no need for alignment. It is understood, however, that different embodiments may indeed require alignment. For example, if the sphere 14 is flat, or if the metal 1 layer 20 is also patterned, the metal 2 layer 28 may indeed need to be patterned. Also, if the entire resist coating cannot be exposed at the same time, alignment between exposures may be required.

Once the resist coating has been fully exposed (to the extent required), the exposed surface can be developed and etched according to conventional techniques. For example, the exposed photo resist and Au/Cr metal 2 layer may be etched according to a technique such as shown in U.S. Pat. No. 6,077,388, issued on Jun. 20, 2000, and also assigned to Ball Semiconductor, Inc., entitled “SYSTEM AND METHOD FOR PLASMA ETCH ON A SPHERICAL SHAPED DEVICE” and hereby incorporated by reference as if reproduced in its entirety. Once etching is complete (and cleaning, if required), the electrodes 28a, 28b, 28c, 28d, and 28e may be fully processed.

At step 34 of FIG. 1, the substrate and processed layers are assembled, as required by a particular application. Referring also to FIG. 5, a plurality of bumps 36a, 36b are applied to the electrodes 28a, 28b, respectively. In the present example, the bumps are gold, but it is understood that other materials may be used, such as solder. The bumps 36a, 36b may also be applied to electrodes 38a, 38b, respectively, of a second substrate 40. Because the sacrificial layer 24 still exists, the process of applying the bumps 36a, 36b to the electrodes 28a, 28b and 38a, 38b is relatively straight forward. For the sake of example, the bump application may be performed by the method described in U.S. Pat. No. 6,251,765, issued on Jun. 26, 2001, and also assigned to Ball Semiconductor, Inc., entitled “MANUFACTURING METAL DIP SOLDER BUMPS FOR SEMICONDUCTOR DEVICES” and hereby incorporated by reference as if reproduced in its entirety.

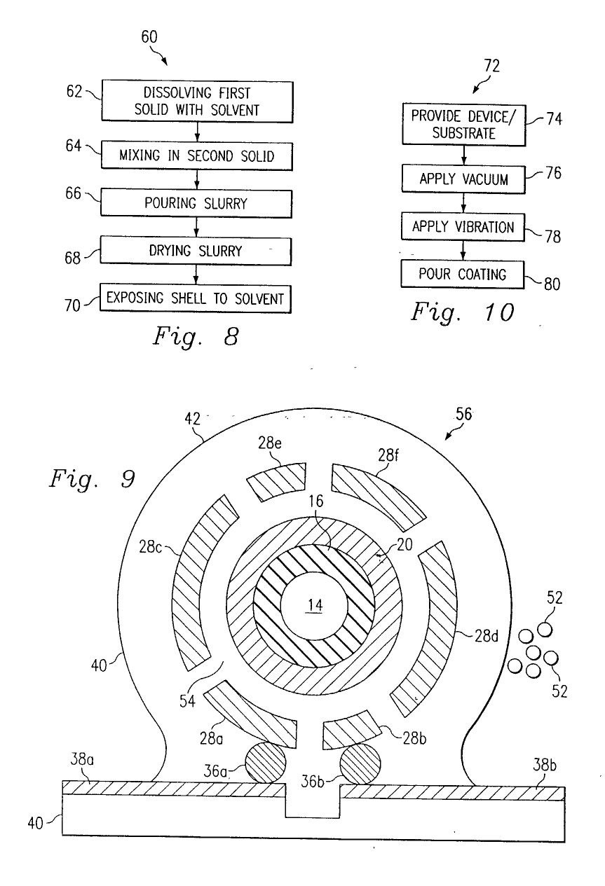

Once the bumps have been applied and attached, a protective coating 42 may be applied as will be described in greater detail in reference to FIGS. 8-11. In the present example of FIG. 5, the protective coating 42 covers all of the electrodes 28a, 28b, 28c, 28d, 28e (and thus the underlying layers and substrates), the bumps 36a, 36b, and at least a portion of the electrodes 38a, 38b. In the present example, the protective coating 42 is ceramic, but may be epoxy resin, polyimide, or any other material. The protective coating 42 may be applied in any manner, including dipping or spraying the coating onto the components to be coated.

The above-described manufacturing process 10 uses conventional processing operations in a new and modified sequence. It is recognized that the processing operations referenced above, or different operations that better suit particular needs and requirements, may be used.

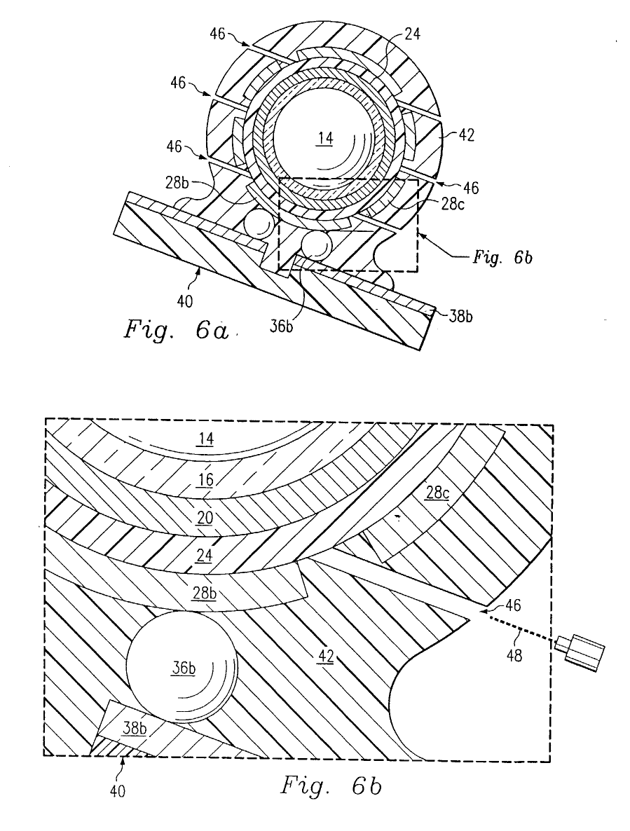

At step 44 of FIG. 1, holes are created in one or more of the processed layers. Referring also to FIGS. 6a and 6b, holes 46 are made through the protective coating 42 and extending between the electrodes 28a, 28b, 28c, 28d, 28e to the sacrificial layer 24. In the preferred embodiment, these holes are made using a laser 48. The laser 48 is positioned to burn the hole directly through the protective coating 42 to reach the sacrificial layer 24. Other ablation methods include particle injection or other chemical and/or mechanical techniques.

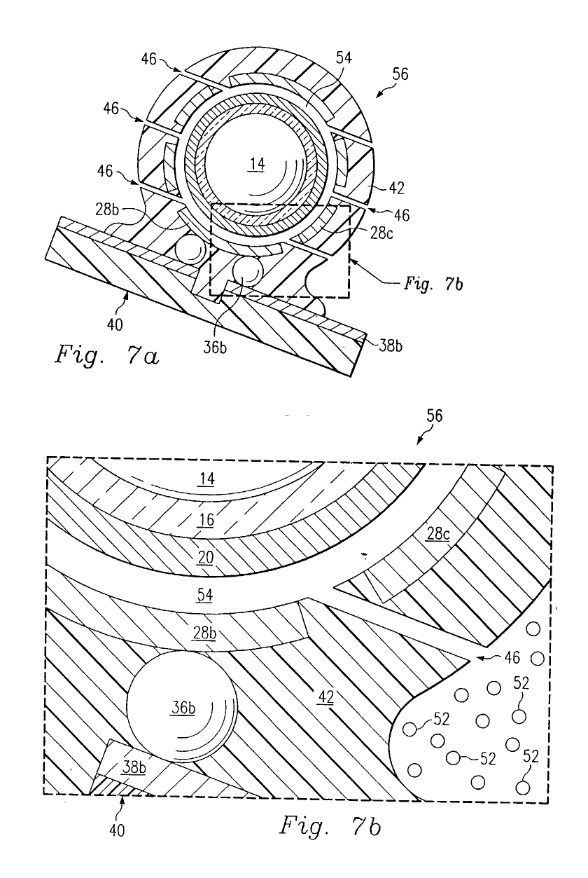

At step 50 of FIG. 1, the sacrificial layer is removed. Referring also to FIGS. 7a and 7b, the sacrificial layer 24 is etched through the holes 46. In continuance of the above examples where the sacrificial layer 24 is polysilicon, a xenon difluoride (XeF2) dry etchant 52 can be used. The XeF2 dry etchant 52 has extremely high selectivity. It readily reacts with crystalline silicon and polysilicon, but does not react with the metal 2 layer 28, the protective coating 42, or various other materials. It is understood that other etchants may be used.

As a result, the sacrificial layer 24 is removed and a gap 54 is formed in its place. The gap 54 separates the sphere 14, SiO2 layer 16, and metal 1 layer 20 (collectively the “core”) from the metal 2 layer 28 (the “shell”). In the present embodiment, the gap 54 extends around the entire core to complete the construction of a three-axis accelerometer 56.

Referring now to FIGS. 8 and 9, in another embodiment, the reference numeral 60 refers, in general, to one embodiment of a manufacturing process for producing a gas permeable shell that surrounds MEMS devices. At step 62, a first solid is dissolved in a solvent to form a solution. The first solid may be boron oxide (B203) or any other material. The solvent may be iso-propyl (IPA) alcohol or any other solvent.

At step 64, the solution from step 62 is mixed with a second solid to form a slurry. The second solid may be alumina cement or any other material. By controlling the amount of mixing in step 64, the size of the pores of the gas permeable shell 42 can be controlled. The size of the pores of the gas permeable shell 42 can be also be controlled by the composition of the slurry.

At step 66, the slurry from step 48 is poured onto the substrate and processed layers. The slurry covers all of the electrodes 28a, 28b, 28c, 28d, 28e, and 28f (and thus the underlying layers and substrates), the bumps 36a, 36b, and at least a portion of the electrodes 38a, 38b. At step 68, the slurry covered substrate and processed layers are dried at room temperature. The second solid may be dispersed in the gas permeable shell 42.

At step 70, the substrate and processed layers are exposed to the solvent. The solvent re-dissolves the first solid leaving behind the gas permeable shell 42. The gas permeable shell 42 has pores that are now interconnected and extend between the electrodes 28a, 28b, 28c, 28d, 28e and 28f to the sacrificial layer 24.

In yet another embodiment, alumina cement may be utilized without the need for a solvent to open the interconnected pores. This simplifies the creation of the protective layer 42.

Referring now to FIG. 9, the sacrificial layer 24 (as shown in FIG. 5) may be etched through the gas permeable shell 42. In continuance of the above examples where the sacrificial layer 24 is polysilicon, a xenon difluoride (XeF2) dry etchant 52 can be used. The XeF2 dry etchant 52 has extremely high selectivity. It readily reacts with crystalline silicon and polysilicon, but does not react with the metal 2 layer 28, the protective coating 42, or various other materials. It is understood that other etchants may be used.

As a result, the sacrificial layer 24 is removed and a gap 54 is formed in its place. The gap 54 separates the sphere 14, SiO2 layer 16, and metal 1 layer 20 (collectively the “core”) from the metal 2 layer 28 (the “shell”). In the present embodiment, the gap 54 extends around the entire core to complete the construction of a three-axis accelerometer 56.

Referring now to FIG. 10, in yet another embodiment, a method 72 for applying the coating 42 is illustrated in greater detail in steps 74-80. At step 74, a device over which the coating is to be applied and, if desirable, a substrate attached to the device are provided as described in greater detail with respect to FIGS. 11 and 12.

Referring also to FIGS. 11 and 12, the accelerometer 56 described above is illustrated without the protective coating 42 that may be applied in step 34 of FIG. 1 (FIG. 11) and with the coating (FIG. 12). It should be noted that the exemplary accelerometer 56 of FIGS. 11 and 12 is illustrated without an outer surface 16 and with additional electrodes 28f and 28g. It is understood that the accelerometer 56 is merely one example of a device that may utilize such a coating 42, and many other devices of varying sizes and shapes may benefit from the application of the coating 42. In the present example, the coating 42 forms a porous, gas permeable ceramic enclosure or shell around the accelerometer 56 and its associated layers.

Due in part to the relatively small scale of the accelerometer 56 (e.g., approximately one millimeter), imperfections in the coating may create problems that might be insignificant in larger scale applications but may render the accelerometer 56 unusable. Accordingly, it may be desirable to achieve a relatively homogenous, void free layer over the accelerometer 56 with the ceramic coating 42.

In the present example, the substrate 40 may be made of a material such as borosilicate glass (e.g., PYREX material by CORNING GLASS WORKS CORPORATION, NEW YORK). An aperture 82 may be formed in the substrate 40 proximate to the bumps 36a, 36b. The aperture 82 may be formed either before or after the accelerometer 56 is connected to the substrate 40, depending on the particular manufacturing process used.

In step 76 of the method of FIG. 10, a vacuum (indicated by arrows 84 in FIG. 12) may be applied to the aperture 82 on the side of the substrate 40 opposite the accelerometer 56 to create a suction. Vibrations may be induced in step 78, as will be described later in greater detail. Accordingly, when a material such as a ceramic slurry is poured over the accelerometer 56 in step 80, the suction draws a portion of the ceramic slurry over the accelerometer 56 and towards the aperture 82. This may aid in the creation of a homogenous, void-free coating 42 over the accelerometer 56. The amount of suction, which in turn may affect the flow of the coating 42, may depend on a number of factors, such as the rate at which the ceramic slurry is applied to the accelerometer 56, the dimensions of the aperture 82, and similar factors.

In still another embodiment, a vibrating device 85 may be attached to the substrate 40 to aid in the even distribution of the ceramic slurry over the accelerometer 56. For example, the vibrating device 85 may be a piezoelectric transducer operable to create a 150 Hertz vibration. The vibrations created by the transducer may aid in homogenizing the coating 42 during application. In addition, this may aid in the prevention of voids in the coating 42. The amount of vibration, which in turn may affect the flow of the coating 42, may depend on a number of factors, such as the consistency of the ceramic slurry.

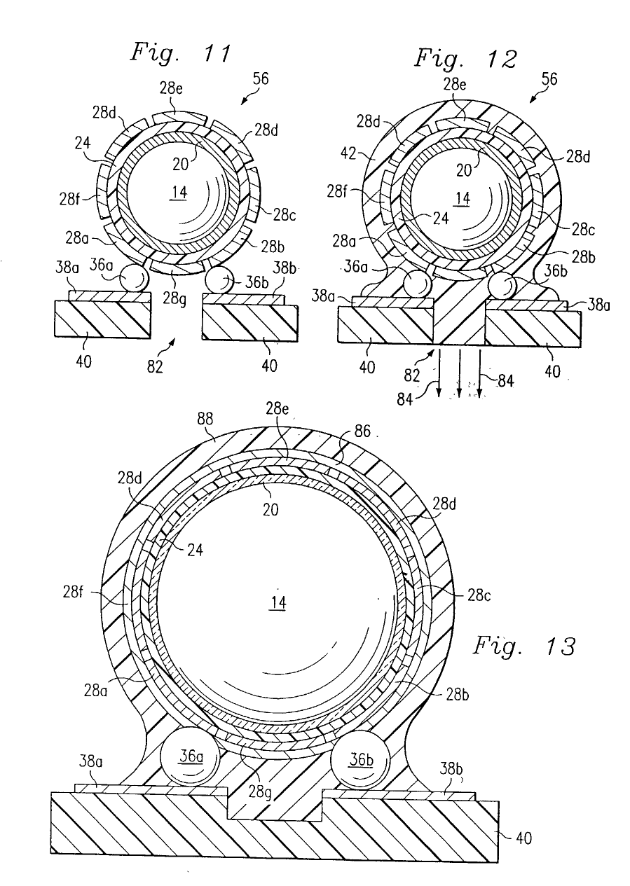

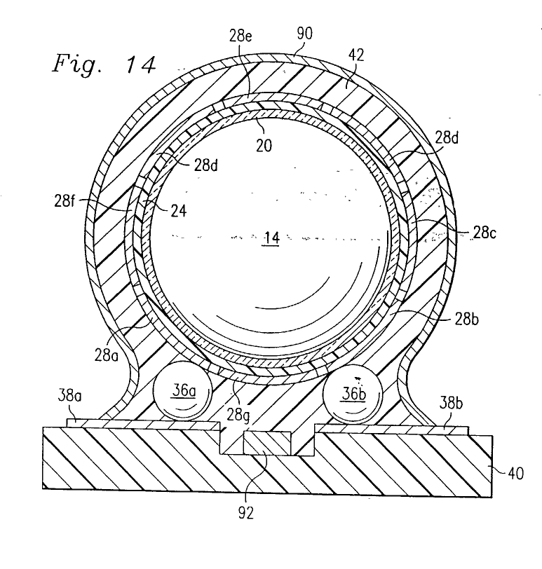

Referring now to FIG. 13, in yet another embodiment, the protective coating 42 may comprise multiple layers of porous material. This may be desirable, for example, if the metal 2 layer 28 and the protective coating 42 do not adhere well to one another. In the present example, the protective layer 42 includes an inner protective layer 86 that provides a desired level of adhesion with the metal 2 layer 28. An outer protective layer 88 can then be added that adheres well to the inner protective layer 86, but that would not adhere well to the metal 2 layer 28. The level of adhesion may vary with the porosity of the inner and outer protective layers 86 and 88, and so the inner protective layer 86 may be less porous than the outer protective layer 88. In this manner, both adhesion and gas permeability may be achieved by using multiple layers of protective coatings.

Referring now to FIG. 14, in still another embodiment, a sealing layer 90 may be deposited on the single or multiple-layer protective coating 42 to provide a hermetic seal. As described previously, the protective coating 42 may comprise one or more gas-permeable layers that enable the sacrificial layer 24 to be etched after the protective coating 42 is applied. However, in certain MEMS applications, it may be undesirable to have a porous protective coating 42. Accordingly, the sealing layer 90 may be deposited onto the protective layer 42 after the etching process to seal the pores provided in the protective layer 42 for the etching process.

In another embodiment, referring still to FIG. 14, a material (a “getter”) 92 may be added proximate to the device 56. For example, the getter 92 may be formed on the substrate 40 and within the protective layer 42 and/or the sealing layer 90. The getter 92 may attract gas molecules during the etching process as well as gas molecules remaining after the etching process. If the sealing layer 90 is deposited on the protective layer 42 after the etching process, the getter 92 may attract gas molecules that are trapped inside the device 56 by the sealing layer 90. Accordingly, the getter 92 may stabilize the device 56.

While the invention has been particularly shown and described with reference to the preferred embodiment thereof, it will be understood by those skilled in the art that various changes in form and detail may be made therein without departing from the spirit and scope of the invention. For example, it is within the scope of the present invention to use a MEMS device of non-spherical shape. Also, it may be desirable to use materials other than ceramic for the coating. Furthermore, the coating may enter certain openings in the MEMS device. Also, it may be desirable to have multiple coatings. Therefore, the claims should be interpreted in a broad manner, consistent with the present invention.

What is claimed is:

1. A method for coating a micro-electromechanical system device, the method comprising:
mounting the device on a substrate, the substrate including an aperture having a first opening proximate to the device and a second opening connected to the first opening;
applying a vacuum to the second opening; and
applying a coating material over the device;
wherein the vacuum aids in the homogeneous distribution of the coating material on the device by drawing a portion of the coating material over the device and towards the first opening.

2. The method of claim 1 further including applying a vibration to the device, the vibration aiding in the homogeneous distribution of the coating material over the device.

3. The method of claim 2 wherein the vibration is applied using a piezoelectric transducer.

4. The method of claim 2 further including defining an amount of vibration to be applied depending on a consistency of the coating material.

5. The method of claim 1 further including defining a strength of the vacuum to be applied depending on the consistency of the coating material.

6. The method of claim 5 further including defining the strength of the vacuum to be applied depending on the dimensions of the aperture.

7. The method of claim 1 further including allowing the coating material to harden into a porous enclosure.

8. A method for applying a coating layer to a micro-electromechanical system device, the method comprising:
applying a vacuum proximate to the device;
applying a vibration to the device; and
pouring a coating material over the device,
whereby the vacuum and the vibration provide a homogenous distribution of the coating material over the device.

9. The method of claim 8 further including allowing the coating material to harden into a gas permeable shell.

10. The method of claim 8 wherein the device is a sphere.

11. The method of claim 8 wherein the device is an accelerometer.

12. The method of claim 8 further including attaching the device to a substrate, the substrate including an aperture having a first opening located proximate to the device and a second opening connected to the first opening, and wherein the vacuum is applied to the second opening and exerts an attractive force that is operable to draw at least a portion of the coating material towards the first opening.

13. A method for increasing adhesion between a micro-electromechanical system device and a gas-permeable outer layer, the method comprising:
applying a gas-permeable inner layer to the device, the inner layer having a high level of adherence to the device; and
applying the outer layer over the inner layer, the outer layer having a lower level of adhesion to the device than the inner layer.

14. The method of claim 13 wherein the outer layer is more porous than the inner layer.

15. The method of claim 13 further including adding at least one gas-permeable middle layer between the inner and outer layers, the middle layer adhering to both the inner and outer layers.

16. The method of claim 15 wherein the middle layer is more porous than the inner layer and less porous than the outer layer.

17. A method for hermetically sealing a micro-electromechanical system device having a gas-permeable exterior coating, the method including:
providing an attractive material operable to attract gas molecules, the attractive material positioned proximate to the device; and
depositing a sealing layer over the device and the attractive material, the sealing layer operable to seal a plurality of pores present in the gas-permeable exterior coating, and the attractive material operable to attract gas molecules trapped inside the device after the sealing layer is deposited.

18. A micro-electromechanical system device, the device comprising:
an inner core;
a sacrificial layer surrounding the core;
a shell surrounding the sacrificial layer and including a first gas-permeable protective layer surrounding the shell;
so that the sacrificial layer can be etched through the first protective layer to allow the core to move within the shell.

19. The device of claim 18 wherein the shell further includes a second gas-permeable protective layer surrounding the first protective layer, wherein the first protective layer provides an adhesive bond between the shell and the second protective layer.

20. The device of claim 18 wherein the shell further includes a sealing layer, the sealing layer operable to seal a plurality of pores present in the first protective layer.

21. The device of claim 20 further including an attractive material, the material operable to attract gas molecules trapped inside the sealing layer.
